(19) United States
(12) Patent Application Publication
(10) Pub. No.: US 2023/0409178 A1
(43) Pub. Date: Dec. 21, 2023

(54) INFORMATION DISPLAY METHOD AND APPARATUS, DEVICE, STORAGE MEDIUM, AND PROGRAM PRODUCT

(71) Applicant: TENCENT TECHNOLOGY (SHENZHEN) COMPANY LIMITED, Shenzhen (CN)

(72) Inventors: Yongqing YUAN, Shenzhen (CN); Fang ZOU, Shenzhen (CN); Kai KANG, Shenzhen (CN); Liang LI, Shenzhen (CN); Xuan HU, Shenzhen (CN)

(21) Appl. No.: 18/457,976

(22) Filed: Aug. 29, 2023

Related U.S. Application Data
(63) Continuation of application No. PCT/CN2022/136876, filed on Dec. 6, 2022.

(30) Foreign Application Priority Data
Jan. 26, 2022 (CN) 202210096106.0

(51) Int. Cl. G06F 3/04842; G06F 3/0481; G06F 3/04845

(52) U.S. Cl. CPC G06F 3/04842; G06F 3/0481; G06F 3/04845; G06F 2203/04806

(57) ABSTRACT

This application discloses an information display method and apparatus, a device, a storage medium, and a program product, relating to the field of computer and Internet technologies. The method includes displaying an interface presenting a map of a geographic region; displaying at least one information label related to the geographic region in the interface, and marking a geographic location associated with the information label on the map, each information label corresponding to at least one piece of information; and displaying information corresponding to a target information label in response to an operation on the target information label.

### RELATED APPLICATIONS

This application is a continuation of PCT Application No. PCT/CN2022/136876, filed on Dec. 6, 2022, which claims priority to Chinese Patent Application No. 202210096106.0, entitled “INFORMATION DISPLAY METHOD AND APPARATUS, DEVICE, STORAGE MEDIUM, AND PROGRAM PRODUCT” filed with the China National Intellectual Property Administration on Jan. 26, 2022. The two applications are incorporated by reference in their entirety.

### FIELD OF THE TECHNOLOGY

This application relates to the field of computer and Internet technologies, and in particular, to an information display method and apparatus, a device, a storage medium, and a program product.

### BACKGROUND OF THE DISCLOSURE

Information applications can provide objects with information such as news, updates, and comments.

In related technologies, information applications usually display information in the form of lists. For example, in an interface, information items are displayed one by one in top-down order. A user may slide the interface to select information corresponding to items of interest for viewing.

### SUMMARY

Embodiments of this application provide an information display method and apparatus, a device, a storage medium, and a program product.

One aspect of the embodiment of this application provides an information display method. The method includes displaying an interface presenting a map of a geographic region; displaying at least one information label related to the geographic region in the interface, and marking a geographic location associated with the information label on the map, each information label corresponding to at least one piece of information; and displaying information corresponding to a target information label in response to an operation on the target information label.

Another aspect of the embodiments of this application provides a computer device. The computer device includes a processor and a memory, the memory stores at least one instruction, at least one program, a code set, or an instruction set, and the at least one instruction, the at least one program, the code set, or the instruction set being loaded and executed by the processor to implement the foregoing information display method.

Another aspect of the embodiments of this application provides a non-transitory computer-readable storage medium. The storage medium stores at least one instruction, at least one program, a code set, or an instruction set, and the at least one instruction, the at least one program, the code set, or the instruction set being loaded and executed by a processor to implement the foregoing information display method.

By combining information and maps, a map of a region and information labels in the region are displayed in the interface, and geographic locations associated with the information labels are marked on the map to achieve associated display of information and geographic locations. The embodiments of this application provide a novel information display method, by which a user can learn a geographic location associated with information more clearly and intuitively, such as learning a location of occurrence of an event contained in the information.

### BRIEF DESCRIPTION OF THE DRAWINGS

FIG. 1 is a schematic diagram of a implementation environment according to an embodiment of this application.

FIG. 2 is a flowchart of an information display method according to an embodiment of this application.

FIG. 3 is a schematic diagram of an information display interface according to an embodiment of this application.

FIG. 4 is a flowchart of an information display method according to another embodiment of this application.

FIG. 5 is a schematic diagram of map form switching according to an embodiment of this application.

FIG. 6 is a schematic diagram of immersive switching of a map according to an embodiment of this application.

FIG. 7a is a schematic diagram of an interface under a category label according to an embodiment of this application.

FIG. 7b is a schematic diagram of an interface under another category label according to an embodiment of this application.

FIG. 7c is a schematic diagram of an interface under another category label according to an embodiment of this application.

FIG. 8 is a schematic diagram of an operation on a target control according to an embodiment of this application.

FIG. 9 is a schematic diagram of determination of a selected region according to an embodiment of this application.

FIG. 10a is a schematic diagram of a head-tail disconnected operation trajectory according to an embodiment of this application.

FIG. 10b is a schematic diagram of an operation trajectory with an intersection point according to an embodiment of this application.

FIG. 11a is a schematic diagram of determination of an operation position according to an embodiment of this application.

FIG. 11b is a schematic diagram of continuous pressing on the operation position according to an embodiment of this application.

FIG. 11c is a schematic diagram of display of an information label in a selected region according to an embodiment of this application.

FIG. 12 is a schematic diagram of specific information display according to an embodiment of this application.

FIG. 13 is a flowchart of an information display method according to another embodiment of this application.

FIG. 14 is a block diagram of an information display apparatus according to an embodiment of this application.

FIG. 15 is a block diagram of an information display apparatus according to another embodiment of this application.

FIG. 16 is a structural block diagram of a terminal device according to an embodiment of this application.

### DESCRIPTION OF EMBODIMENTS

To make the objectives, technical solutions, and advantages of this application clearer, the following further describes implementations of this application in detail with reference to the accompanying drawings.

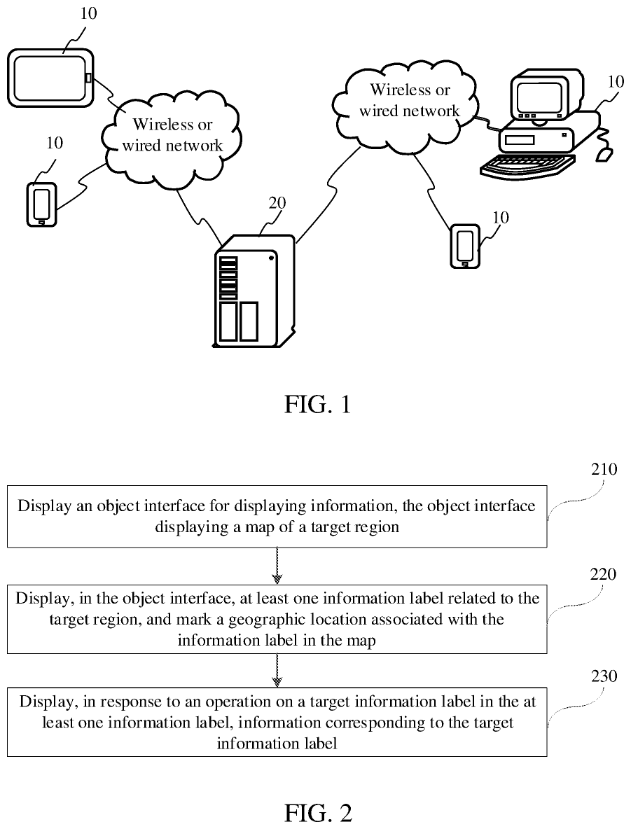

FIG. 1 shows a schematic diagram of a implementation environment according to an embodiment of this application. The implementation environment may be implemented as an information display system. The implementation environment may include: a terminal device 10 and a server 20.

The terminal device 10 may be an electronic device such as a mobile phone, a tablet computer, a personal computer (PC), a wearable device, a vehicle terminal device, a virtual reality (VR) device, or an augmented reality (AR) device, which not limited by the descriptions of this application. A client running a target application may be installed in terminal device 10. In some embodiments, the target application may be an application with a display function for information. For example, the target application may be an information display application, a browser application, a social application, an instant messaging application, a video playback application, or a map application, which not limited by the descriptions of this application.

The server 20 may be an independent physical server, a server cluster or distributed system including a plurality of physical servers, or a cloud server providing cloud computing services. The server 20 may be a backend server of the foregoing target application for providing backend services for a client of the target application, such as providing news or other information for a client.

In some embodiments, the foregoing target application may be a separately developed independent application (APP), a mini program, or other forms of applications such as a web application, which not limited by the descriptions of this application.

FIG. 2 shows a flowchart of an information display method according to an embodiment of this application. An executive subject of this method may be the terminal device 10 in the implementation environment shown in FIG. 1, for example, each step may be executed by the client of the target application. The method may include at least one of the following steps (210-230):

Step 210: Display an interface for displaying information, the interface displaying a map of a target region.

The information has timeliness and regionality, and timely information can be provided for a user of the client. The information may be in the form of text, images, videos, or the like. In some embodiments, the information may alternatively be a combination of the foregoing various forms of information. For example, the information may be an article in a combined form of images and text.

The interface is a human-computer interaction interface provided by the client. The client may display the information in the interface, and correspondingly, a target object may view the information in the interface. In some embodiments, in the interface, the target object may filter the information. After the target object selects a condition corresponding to the information, information of the corresponding condition is displayed in the interface. For example, when the filtering condition selected by the target object to display information is “sports”, the interface displays information related to “sports”.

In this embodiment, the interface displays the map of the target region, where the target region is a geographic location region, and the target region may be one or more countries, one or more provinces, one or more cities, one or more townships, one or more communities, a region(s) where one or more buildings are located, or the like. This application does not define the scope of the target region. The target region may be selected by the target object or by the client, which not limited by the descriptions of this application. The target object may adjust the size of the target region, for example, change a size of the target region from one city to two cities.

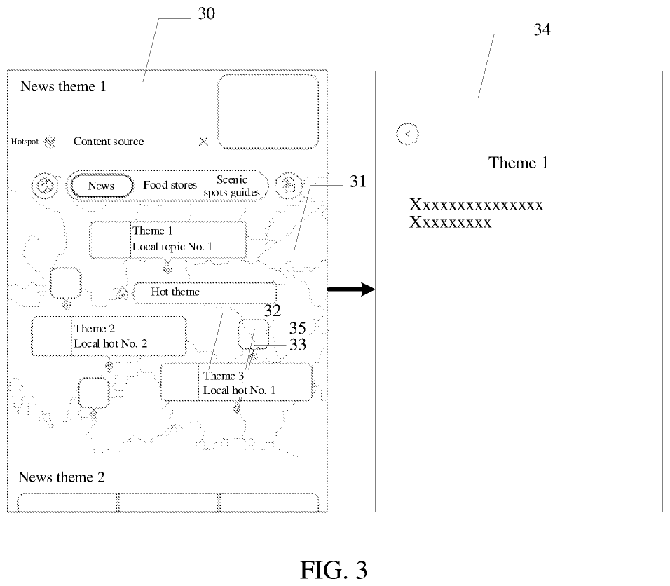

For example, as shown in FIG. 3, the client displays an interface 30 for displaying information, and the interface 30 displays a map 31 of a target region. For example, the target region may be a geographic location region containing one or more cities.

Step 220: Display, in the interface, at least one information label related to the target region, and mark a geographic location associated with the information label on the map, where each information label corresponds to at least one piece of information.

The information label is a label corresponding to information, and displays an overview information (or brief information). The overview information displayed on the information label may be in a form of text, images, videos, or the like. In addition, the information label may be an operable control, and the target object clicks the information label by means of an operating body such as a finger or a mouse to trigger display of the information corresponding to the information label. The information label briefly displays information in the form of a title or introduction. The title and introduction are used for summarizing content of the information, and the target object may obtain the overview information of the information through the title and introduction. In the interface, the corresponding information is displayed by displaying the information label.

In some embodiments, the information is associated with a geographic location, which may be a geographic location related to an event contained in the information. For example, the geographic location may be a location of occurrence, passage, or end of the event contained in the information. In addition, due to the corresponding relationship between the information and the information labels, the geographic location associated with the information may also be referred to as the geographic location associated with the information label. For example, a geographic location associated with an information label is city A, indicating that a geographic location associated with information corresponding to the information label is city A. For example, information related to an event occurring in city A may be associated with city A.

The information label displayed in the interface is an information label related to the target region, and whether the information label is related to the target region is determined according to the geographic location associated with the information label. For example, if the target region is city A and the geographic location associated with an information label is community A in city A, the information label is related to the target region and will be displayed in the target region of the interface. If the target region is city A and the geographic location associated with an information label is community B in city B, the information label is not related to the target region and will not be displayed in the interface. A plurality of information labels may be displayed in the interface, and a plurality of information labels related to the target region may be displayed in the target region of the interface. In addition, one or more information labels may be related to the target region, and the interface may display all or some of the information labels related to the target region. For example, when a lot of information labels are related to the target region, only a few information labels related to the target region may be selected for display in consideration of the limited size of the interface. In some embodiments, the target object may update, through an update control, the information labels related to the target region displayed in the interface.

In addition, each information label corresponds to at least one piece of information. In a case that an information label corresponds to a piece of information, the target object clicks the information label through an operating body to trigger display of the piece of information corresponding to the information label. In a case that an information label corresponds to a plurality of pieces of information, the target object clicks the information label through an operating body to trigger display of the plurality of pieces of information corresponding to the information label. In some embodiments, in the case that the information label corresponds to the plurality of pieces of information, the plurality of pieces of information may be displayed simultaneously, or only one piece may be displayed and then switched according to an operation of the target object to display information. This application does not limit how to display the plurality of pieces of information.

In this embodiment, the interface displays the map of the target region and at least one information label related to the target region. Moreover, the geographic location associated with an information label is marked on the map, and the target object is enabled to intuitively learn the geographic location associated with the information, such as a location of occurrence of an event contained in the information. For example, as shown in FIG. 3, the interface 30 displays a map 31 of a target region and at least one information label 32 associated with the target region. A geographic location associated with the information label 32 is marked on the map 31 through a marking point 33. Moreover, the information label 32 may display overview information of corresponding information, such as a title or introduction.

Step 230: Display, in response to an operation on a target information label in at least one information label, information corresponding to the target information label.

The target information label may be any one or more of the at least one information label displayed in the interface. An information display interface is displayed in response to the operation on the target information label in the at least one information label, and the information corresponding to the target information label is displayed in the information display interface. In the process of displaying the information display interface, the display of the interface for displaying information labels may be canceled or maintained. For example, the information display interface may be a floating window located on an upper layer of the interface for displaying information labels; or the interface for displaying information labels is switched to the information display interface. For example, if the target information label corresponds to one piece of information, the information may be displayed alone through a full screen or half screen. If the target information label corresponds to a plurality of pieces of information, the information being viewed may be displayed alone on a full screen or half screen, and other information may be displayed in the form of floating windows.

The target object may click the information label in the interface to view information. For example, as shown in FIG. 3, when the target object clicks the information label 32, the client displays an information display interface 34, and information corresponding to the information label 32 is displayed in the information display interface 34.

According to the technical solution provided in this embodiment, by combining information and maps, a map of a region and information labels in the region are displayed in the interface, and geographic locations associated with the information labels are marked on the map to achieve associated display of information and geographic locations. This embodiment provides a novel information display method, by which a user can learn a geographic location associated with information more clearly and intuitively, such as learning a location of occurrence of an event contained in the information.

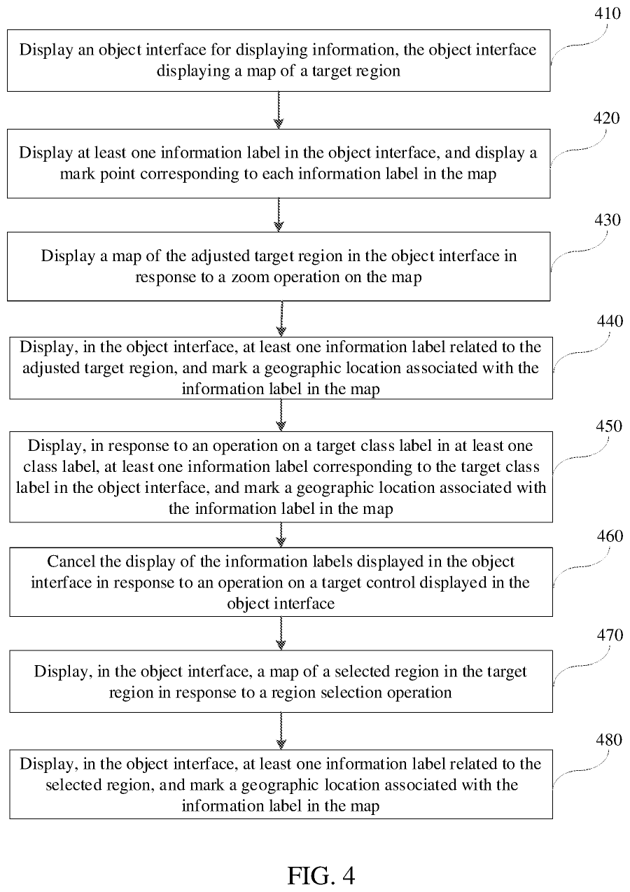

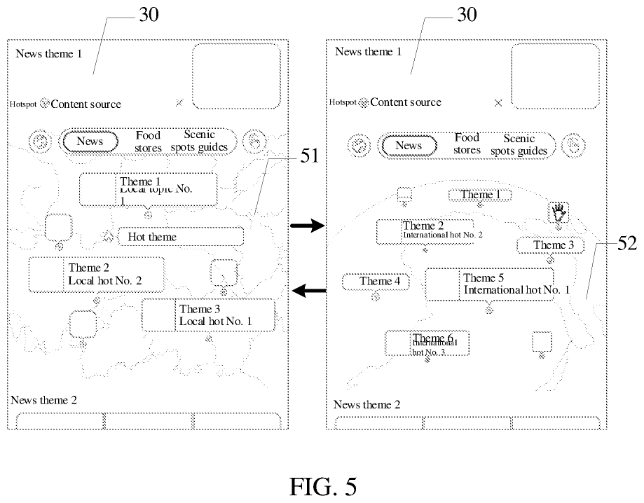

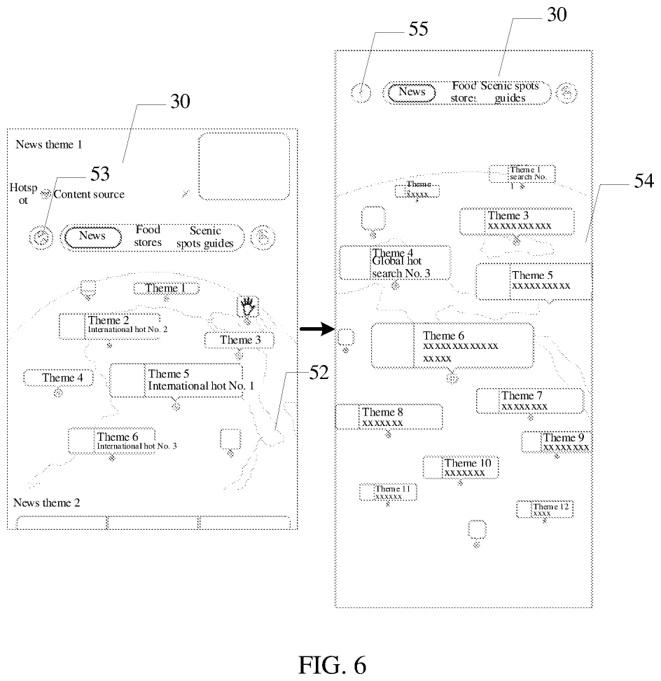

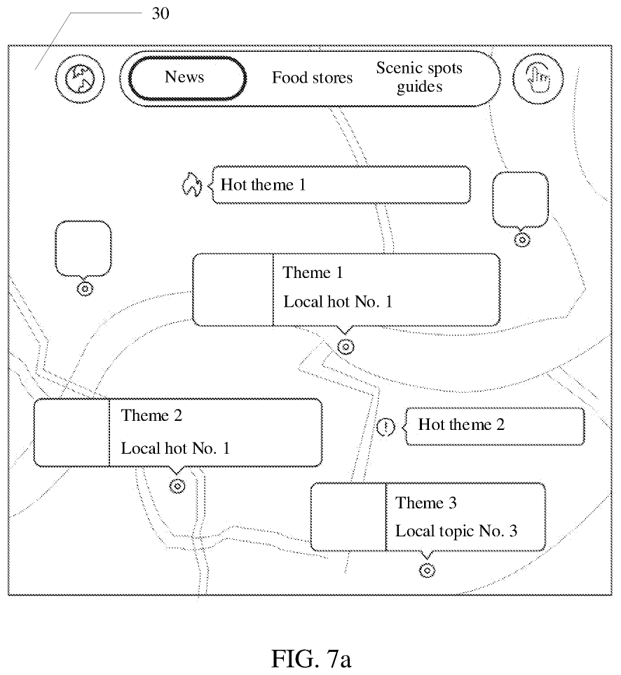

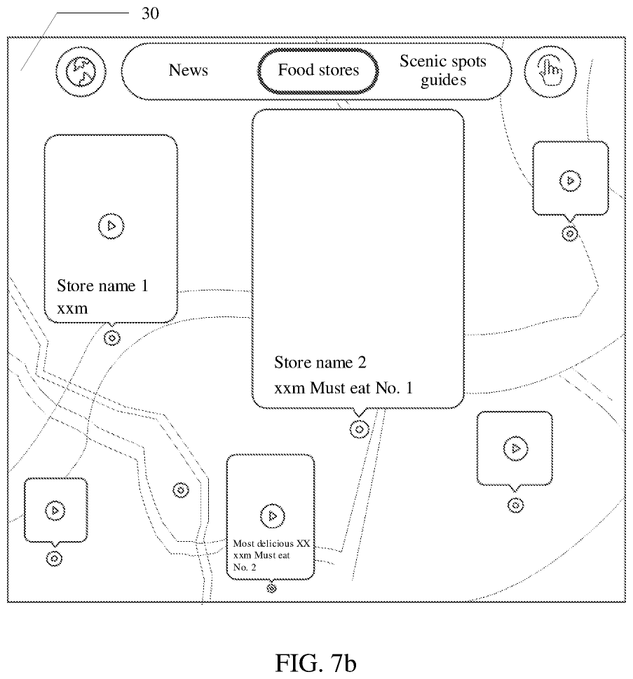

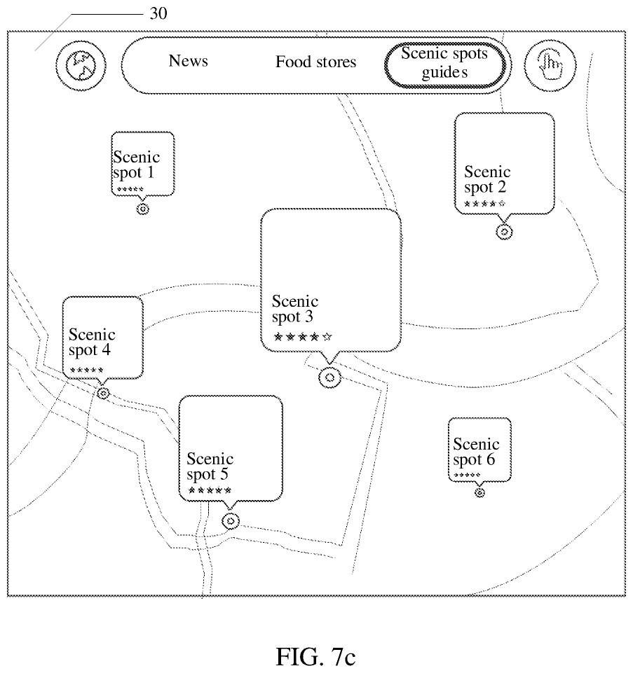

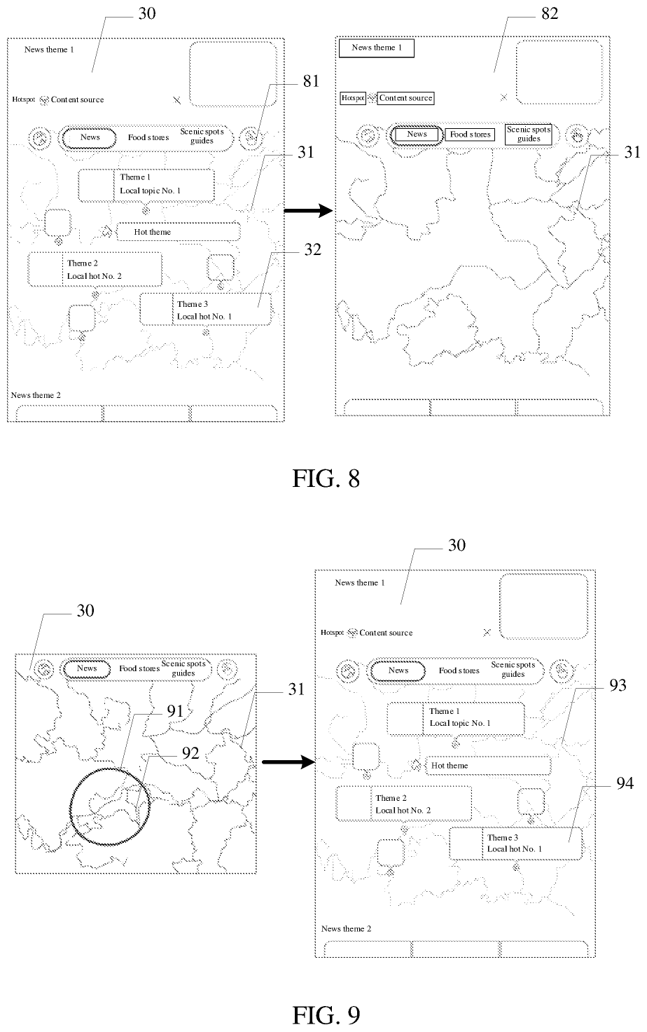

FIG. 4 shows a flowchart of an information display method according to another embodiment of this application. An executive subject of this method may be the terminal device 10 in the implementation environment shown in FIG. 1, for example, each step may be executed by the client of the target application. The method may include at least one of the following steps (410-480):
Step 410: Display an interface for displaying information, the interface displaying a map of a target region.
Step 420: Display at least one information label in the interface, and display a marking point corresponding to each information label on the map, where the information label and the marking point corresponding to the information label are associatively displayed, and a display position of the marking point corresponding to the information label on the map corresponds to a geographic location associated with the information label.
The marking point corresponding to the information label is used for making the geographic location associated with the information label on the map, that is, the display position of the marking point on the map is the geographic location associated with the corresponding information label. For example, a geographic location associated with an information label is community A in city A, the information label is marked with a marking point, and a display position of the marking point corresponding to the information label on the map is community A in city A.
The client displays the marking point on the map according to the display position of the marking point corresponding to the information label on the map, where the information label is displayed near the corresponding marking point, and the information label is associatively displayed with the marking point through a marker. The marker is used for representing an association between the information label and the marking point, and the marker may be in a form of an arrow, a line, or the like. In some embodiments, the marker may not be displayed, but the information label and the marking point are fused together to indicate the association between the information label and the marking point.
For example, as shown in FIG. 3, the marker 35 is in an arrow style, and the information label 32 and the marking point 33 are associatively displayed through the marker 35.
Step 430: Display a map of the adjusted target region in the interface in response to a zoom operation on the map.
The zoom operation is an operation performed by the target object to adjust a zoom ratio of the map. For example, the target object operates on a screen of the terminal device through an operating body to adjust the zoom ratio of the map. For example, in a case that the operating body represents fingers, the target object performs stretching or pinching on the terminal device with double fingers to adjust the zoom ratio of the map; or in a case that the operating body represents a mouse, the target object rotates a mouse wheel up or down to adjust the zoom ratio of the map. In some embodiments, the zoom ratio of the map is equal to a display size of the geographic location region divided by an size of the geographic location region. The zoom ratio of the map is used for representing a degree to which the map is zoomed. In some embodiments, the zoom operation may alternatively adjust the zoom ratio of the map through a zoom control in the interface. The zoom control may be a control that adjusts the zoom ratio of the map. The target object operates the zoom control to adjust the zoom ratio of the map. This application does not limit the implementations of the zoom operation.
The size of the geographic location region is an actual magnitude of the geographic location region, and is a fixed value. For example, the geographic location region is city A, the magnitude of city A is 1000 square kilometers, and the actual size of the geographic location region is 1000 square kilometers. The display size of the geographic location region is a magnitude of the geographic location region displayed in the client, and changes with the zoom operation. In some embodiments, as the map is zoomed in, the display size of the geographic location region increases, and the zoom ratio of the map also increases. As the map is zoomed out, the display size of the geographic location region decreases, and the zoom ratio of the map also decreases. The display size of the geographic location region is not limited by the screen size of the terminal device. When the display size of the geographic location region is zoomed in to be greater than the screen size of the terminal device, the display size of the geographic location region is still the zoomed size.
In some embodiments, a display style of the map includes: a two-dimensional plane style and a three-dimensional style. Step 430 includes: displaying, in the two-dimensional plane style, the map of the adjusted target region in the interface in a case that the zoom ratio of the map satisfies a first condition; or displaying, in the three-dimensional style, the map of the adjusted target region in the interface in a case that the zoom ratio of the map satisfies a second condition.
The first condition is set based on the first threshold of the zoom ratio, and the second condition is set based on a second threshold of the zoom ratio. In some embodiments, the first condition includes that the zoom ratio of the map is greater than or equal to the first threshold, and the second condition includes that the zoom ratio of the map is less than or equal to the second threshold. The first threshold is greater than or equal to the second threshold. In this case, when the zoom ratio of the map is greater than or equal to the first threshold, the map of the adjusted target region is displayed in the two-dimensional plane style in the interface; or when the zoom ratio of the map is less than or equal to the second threshold, the map of the adjusted target region is displayed in the three-dimensional style in the interface.
In some embodiments, FIG. 5 illustrates a schematic diagram of map form switching. In FIG. 5, when a two-dimensional map 51 is displayed in the two-dimensional plane style in the interface 30, the zoom ratio of the map may be decreased to be less than or equal to the second threshold through a zoom-out operation of the operating body, and a three-dimensional map 52 is displayed in the three-dimensional style in the interface 30. Similarly, when the three-dimensional map 52 is displayed in the three-dimensional style in the interface 30, the zoom ratio of the map may be increased to be greater than or equal to the first threshold through a zoom-in operation of the operating body, and the two-dimensional map 51 is displayed in the two-dimensional plane style in the interface 30. The foregoing first threshold and second threshold may be set based on specific requirements, which not limited by the descriptions of this application.
In some embodiments, FIG. 6 illustrates a schematic diagram of immersive switching of a map. In FIG. 6, the three-dimensional map 52 is displayed in the interface 30. The target object may click an immersive switching control 53 to switch the original half-screen displayed three-dimensional map 52 to a full-screen displayed immersive map 54. Meanwhile, the full-screen displayed immersive map may be switched back to the half-screen displayed three-dimensional map 52 by means of a cancel button 55. In some embodiments, the two-dimensional plane map also includes an immersive map mode.
Step 440: Display, in the interface, at least one information label related to the adjusted target region, and mark a geographic location associated with the information label on the map.
After the target object performs the zoom operation on the map, the map of the adjusted target region is obtained, and the client updates and displays information in the adjusted target region. In some embodiments, the client cancels the display of information in the original target region and re-displays information in the adjusted target region. In some embodiments, the client simultaneously displays information labels in the original target region and information in the adjusted target region. The expression “mark a geographic location associated with the information label on the map” is explained earlier and will not be repeated here.
Step 450: Display, in response to an operation on a target category label in at least one category label, at least one information label corresponding to the target category label in the interface, and mark a geographic location associated with the information label on the map.
The interface further displays at least one category label, and different category labels correspond to information labels belonging to different information categories. The information categories may be previously divided based on content of information, such as sports, variety shows, movies, and landscapes. This application does not limit a specific division and types of the information categories, which may be set based on specific requirements. In addition, the category label is a label of an information category, for example, the category label may include a name of the information category.
The target category label is one or more category labels selected by the target object from the at least one category label displayed in the interface. In some embodiments, the client displays, according to the target category label selected by the target object, at least one information label corresponding to the target category label in the interface. For example, when the target category label is under an information category of sports, the interface displays information labels related to sports. For another example, when the target category label is under a plurality of information categories such as sports and scenery, the interface displays information labels related to sports and scenery.
In some embodiments, FIG. 7a to FIG. 7c illustrate schematic diagrams of interfaces under different category labels. The interface 30 displays a plurality of different category labels, such as “News”, “Food stores”, and “Scenic spots guides”. FIG. 7a shows information labels about the category label “News”, FIG. 7b shows information labels about the category label “Food stores”, and FIG. 7c shows information labels about the category label “Scenic spots guides”.
In some embodiments, the at least one category label displayed in the interface includes at least one of the following:
1. Category label selected or set by the target object.
In some embodiments, the client provides a category intention survey to the target object, and the client provides a corresponding custom label for the target object according to a category intention survey result of the target object. For example, the category intention survey result of the target object is “inference drama”, and the client provides a custom label “inference drama” for the target object.
In some embodiments, the client provides category intention surveys to a plurality of objects, and the client provides a custom label according to the most one or several category labels selected by the plurality of objects in the category label intention surveys. For example, the category intention survey results include a plurality of category labels as follows: “inference dramas”, “ball games”, and “mountaineering”. The number of choices for “inference dramas” is 100, the number of choices for “ball games” is 30, the number of choices for “mountaineering” is 15, and the client provides the custom label “inference dramas” for the plurality of objects.
2. Category label determined based on a historical preference of the target object.
The client obtains a most frequent category label included in historical information labels viewed by the target object, determines the category label as a historical preference category of the target object, and provides the category label to the target object. For example, the historical information labels viewed by the target object include a plurality of category labels as follows: “inference dramas”, “ball games”, and “mountaineering”. The number of occurrences of “inference dramas” is 100, the number of occurrences of “ball games” is 30, the number of occurrences of “mountaineering” is 15, and the client provides the category label “inference dramas” for the target object.
3. Category label determined based on an attribute feature of the target object.
A category label suitable for an interest of the target object is predicted and obtained through a machine learning method according to the attribute feature of the target object, and is provided to the target object.
By setting the custom label, a user's usage requirement is met, and the object can obtain information that better meets its own requirement.
Step 460: Cancel the display of the information labels displayed in the interface in response to an operation on a target control displayed in the interface.
The target control is an operable control used for triggering clearing of information labels displayed in the interface. For example, the target control may be a button. In some embodiments, before the target object selects a region, the target object clicks the target control, and the client cancels the display of all the information labels displayed in the interface. In some embodiments, as shown in FIG. 8, FIG. 8 illustrates a schematic diagram of an operation on a target control. After a target control 81 is clicked in the interface 30, the interface 30 is switched to a region selection interface 82. As shown on the right of FIG. 8, the region selection interface 82 displays only the map 31 of the target region and does not display the information label 32.
By canceling the display of all information labels on the map of the target region before region selection, the interface during object's region selection is more concise and clearer, the object can perform the region selection more clearly, and the final region selection result is more accurate.
Step 470: Display, in the interface, a map of a selected region in the target region in response to a region selection operation.
Step 480: Display, in the interface, at least one information label related to the selected region, and mark a geographic location associated with the information label on the map.

The target object performs the region selection operation to determine the selected region on the map of the target region displayed in the interface. The selected region is a region determined by the target object through the region selection operation and desired to obtain information. For example, the target region displayed in the interface is city A, and the information that the target object desires to obtain is information about community A in city A. The target object determines the selected region through the region selection operation, and the selected region is community A in city A. Therefore, an information label of community A in city A is displayed in the interface.

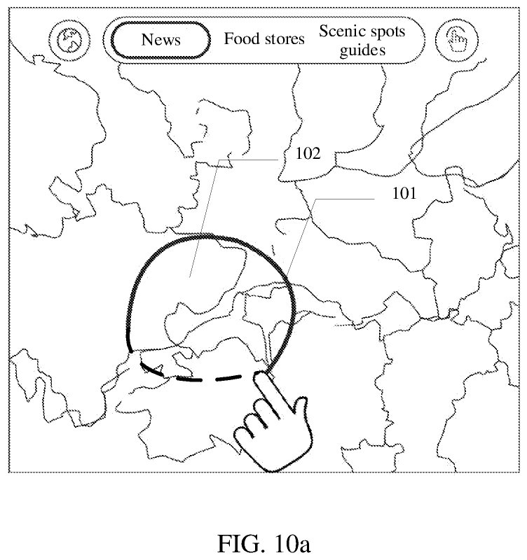

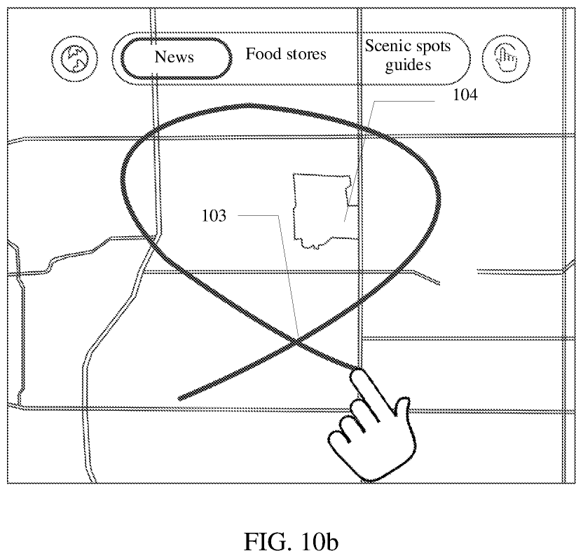

In a possible implementation, step 470 may include steps 471-473 as follows:
Step 471: Obtain an operation trajectory corresponding to the region selection operation in response to the region selection operation.
The target object may control the operating body on the map corresponding to the target region to select a region. The client obtains the operation trajectory of the operating body controlled by the target object on the map. In some embodiments, the operation trajectory may be displayed through a line in the interface.
In some embodiments, as shown in FIG. 9, FIG. 9 illustrates a schematic diagram of a switching display process of information labels. The map 31 of the interface 30 in FIG. 9 shows an operation trajectory 91 of the operating body.
Step 472: Determine the selected region from the target region based on the operation trajectory.
The client determines a region enclosed by the operation trajectory of the operating body slid by the target object on the map as the selected region. As shown in FIG. 9, a region enclosed by operation trajectory 91 in FIG. 9 is the selected region 92.
In some embodiments, the foregoing method for determining a selected region requires the operation trajectory of the operating body to be a head-tail connected graph. When the operation trajectory of the operating body is disconnected at head and tail, the selected region may be determined in the following two methods (1 and 2).
1. In some embodiments, when the operation trajectory of the operating body of the target object on the map cannot enclose a region, that is, when the operation trajectory of the operating body of the target object on the map is disconnected at head and tail, the client may automatically connect the operation trajectory of the operating body of the target object on the map to determine the corresponding selected region.
In some embodiments, as shown in FIG. 10a, FIG. 10a illustrates a case where the operation trajectory is disconnected at head and tail. In this case, the client may automatically connect the operation trajectory 101 (as shown by a real segment) of the operating body to determine a region 102 (a region jointly enclosed by the real segment and imaginary segments) as the selected region.
2. In some embodiments, when the operation trajectory of the operating body of the target object on the map has an intersection, the client may determine an intersection point of the operation trajectory of the operating body of the target object on the map as a starting point and an end point of the operation trajectory of the operating body of the target object on the map, thereby determining the selected region.
In some embodiments, as shown in FIG. 10b, FIG. 10b illustrates a case that the operation trajectory of the operating body of the target object on the map has an intersection point. In this case, the customer may determine the intersection point 103 of the operation trajectories of the operating body of the target object on the map as a starting point and an end point, thereby determining a region 104 as the selected region.
Step 473: Display the map of the selected region in the interface.

For example, as shown in FIG. 9, after determining the selected region 92, the client displays, in the interface 30, the map 93 of the selected region 92 and the information label 94 in the selected region 92.

The location of the selected region is determined through the operation trajectory of the operating body of the target object on the map, and the object is enabled to select a region desired to display information, to obtain the information desired by the object and meet a demand of the object.

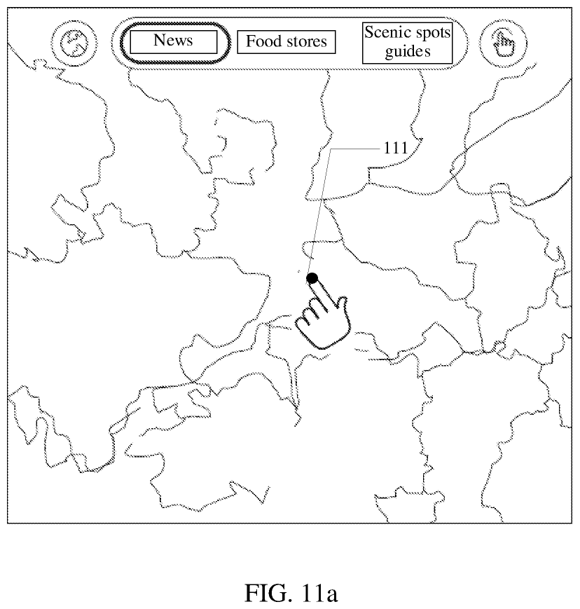

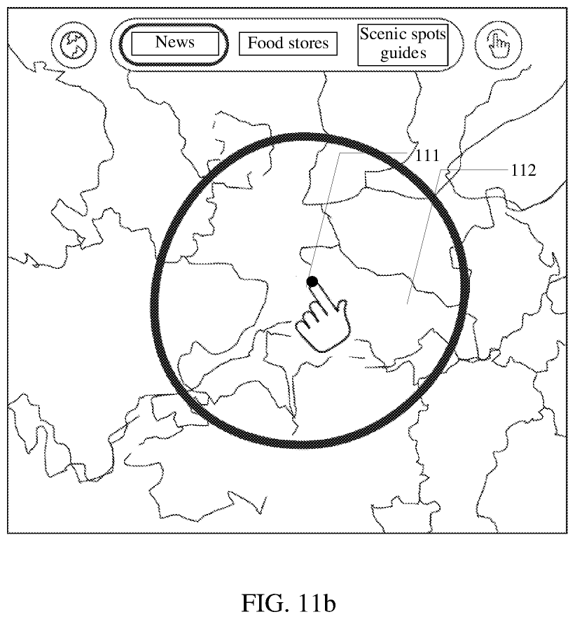

In another possible implementation, step 470 may include steps 474-476 as follows:
Step 474: Obtain an operation position and operation duration corresponding to the region selection operation in response to the region selection operation.
In some embodiments, the region selection operation is a long-press operation, and the target object long-presses a position on the map of the interface through the operating body to select a region. The client obtains the operation position and operation duration corresponding to the long-press operation according to the long-press operation of the target object.
Step 475: Determine the selected region from the target region based on the operation position and operation duration.
The client selects a region containing the operation position in the target region according to the operation position and operation duration corresponding to the long-press operation performed by the target object. The size of the selected region is determined based on the operation duration of the target object. In some embodiments, the size of the selected region is positively correlated with the operation duration, and the longer operation duration indicates a larger selected region. In some embodiments, the selected region is a region centered around the operation position, and the size of the selected region is determined based on the operation duration. In some embodiments, as shown in FIG. 11a to FIG. 11c, FIG. 11a to FIG. 11c illustrate schematic diagrams of another determination of a selected region. As shown in FIG. 11a, an operation position 111 is long-pressed in the interface 30 to obtain a selected region 112 as shown in FIG. 11b. Then, as shown in FIG. 11c, after the hand leaves, the selected region 112 is zoomed in and displayed in the interface 30, and an information label 113 located in the selected region 112 is displayed.
Step 476: Display the map of the selected region in the interface.

The location of the selected region is determined through the long-press operation of the object on the map, and the object is enabled to select a region desired to display information, to obtain the information desired by the object and meet a demand of the object.

The above only provides an introduction to two methods for determining the selected region. In the embodiments of this application, other methods may also be used for determining the selected region. For example, the selected region may alternatively be determined through region selection, where the client divides the map corresponding to the target region into a plurality of sub-regions. For example, province A is divided into a plurality of sub-regions such as city A, city B, and city C, and city A is divided into a plurality of sub-regions such as community A, community B, and community C. The selected region is determined according to one or more sub-regions selected by the target object.

By customizing, the object selects information about a desired region, which meets object's filtering requirements for information. Meanwhile, product diversity is improved through different region selection operations.

In this embodiment, the three function points of zoom adjustment on the map of the target region, selection of the target category labels, and selection of the selected region are decoupled and independent of each other, and the three function points may appear alone or simultaneously, which not limited by the descriptions of this application.

In this embodiment, the object selects information about a desired region through the region selection operation, which meets object's filtering requirements for information. Meanwhile, product diversity is improved through different region selection operations.

Second, by canceling the display of all information labels on the map of the target region before the map selection operation, the interface during object's region selection is more concise and clearer, the object can perform the region selection more clearly, and the final region selection result is more accurate.

Further, information is displayed in different map sizes and map display styles through map zooming and switching of the map display styles, to embody many functions of the product, meet the requirements of different objects, and increase object experience.

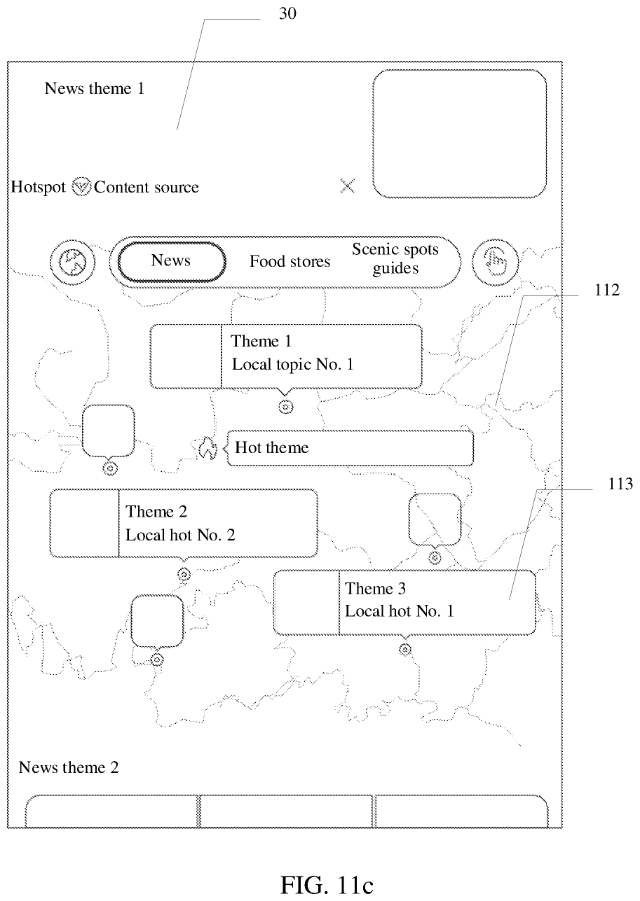

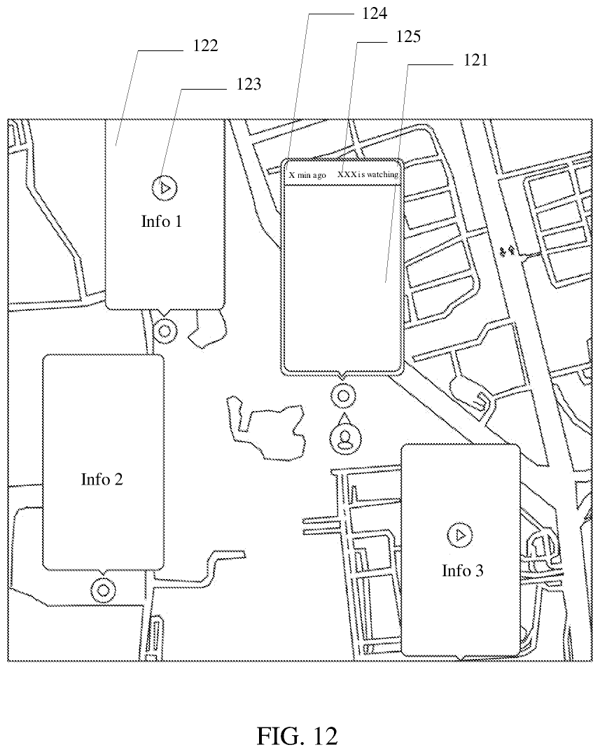

In some embodiments, as shown in FIG. 12, FIG. 12 illustrates a schematic diagram of an interface for displaying specific information.

For an information label corresponding to specific information, a video playback window is displayed in the information label corresponding to the specific information, and video content of the specific information is played in the video playback window. The information label corresponding to the specific information further displays at least one of the following information: occurrence time of the specific information, views of the specific information, and alarm prompt for the specific information.

The specific information refers to information containing a specific display form. In some embodiments, the specific information may be information with a video playback window, and the target object plays video content of the specific information through the video playback window. As shown in FIG. 12, information 121, information 122, and the like in FIG. 12 are specific information, and the target object may click a play button 123 to play the video content of the specific information. The information label corresponding to the specific information further includes information about occurrence time of the specific information 124, views of the specific information 125, alarm prompt for the specific information, and the like.

In this embodiment, the content of information is more specific and richer through specific information, namely, information containing video content.

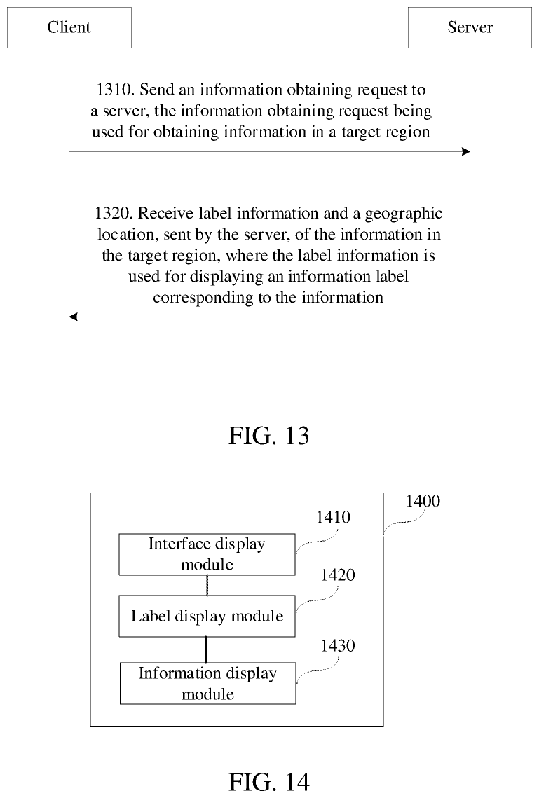

FIG. 13 shows a flowchart of an information display method according to another embodiment of this application. An executive subject of this method may be the terminal device 10 in the implementation environment shown in FIG. 1, for example, each step may be executed by the client of the target application. The method may include at least one of the following steps (1310-1320):

Step 1310: Send an information obtaining request to a server, the information obtaining request being used for obtaining information in a target region.

In some embodiments, the information obtaining request includes indication information of the target region, such as a region name or geographic location coordinates of the target region, to inform the server of which region to obtain information from.

Step 1320: Receive label information and a geographic location, sent by the server, of the information in the target region, where the label information is used for displaying an information label corresponding to the information.

After receiving the label information and geographic location, sent by the server, of the information in the target region, the client may display the information label corresponding to the information according to the label information of the information. In addition, the client may determine a display position of the information label corresponding to the information in a map according to the geographic location of the information.

Moreover, the server may send information while sending the label information and geographic location of the information, or send information corresponding to a target information label after a user selects the target information label, thereby avoiding unnecessary data transmission consumption.

This embodiment only introduces a method that the client obtains the label information and geographic location of information in the target region. Methods of obtaining label information and a geographic location of information in another target region such as an adjusted target region or a selected region are similar, and details will not be repeated.

In some embodiments, the information display method further includes at least one of the following three methods:
Method A: Display each information label in a different display style based on index information corresponding to each information label, where the index information includes at least one of the following: hot, views, occurrence time, and likes.
The information labels are displayed in different display styles on the map according to the index information corresponding to the respective information labels. For example, the information labels corresponding to hot information are displayed in a highlighted format, while the information labels corresponding to low hot information are displayed in a non-highlighted format. For another example, the information labels corresponding to information sent at the closest time to the current time are preferentially displayed. This application does not limit the different display styles of the information labels. For example, the different display styles may be distinguished in terms of color, brightness, size, and the like.
Method B: Display a map of an initial region in the interface in a case of initial display of the interface, where the initial region includes any one of the following: a current region of the target object, a set region of the target object, a historical focus region of the target object, and a preference focus region of the target object; and display at least one information label related to the initial region in the interface, and mark a geographic location associated with the information label on the map.
The historical focus region refers to a geographic location associated with information browsed by the target object last time. The preference focus region is a region with most geographic locations associated with information browsed by the target object. Information of the corresponding region is displayed in the interface according to the initial region selected by the target object.
Method C: Obtain a real-time region of the target object at a set time interval, display a map of the real-time region in the interface, display at least one information label related to the real-time region in the interface, and mark a geographic location associated with the information label on the map.

The client obtains the geographic location of the target object through a global positioning system (GPS) or other positioning methods, and displays information of the geographic location of the target object in the interface. The client updates the information label of the region where the target object is located in real time according to the set time interval. The set time interval may be the same, such as updating every 5 minutes. The set time interval may alternatively be different, for example, the first time interval is 5 minutes, and the second time interval is 3 minutes, which not limited by the descriptions of this application.

In some embodiments, the information label of the region where the target object is located may be updated in real time according to a moving distance of the target object. For example, the information label corresponding to the region where the target object is located is updated every 5 kilometers that the target object moves.

This embodiment introduces the display of information through many methods. Method A displays information labels in different display formats according to the index information of the information labels, and focuses on the display of information labels of important index information, thereby facilitating object's identification on information, enabling the object to quickly find hot information, and saving object's time. Method B displays information labels according to the conditions set by the object, and provides information labels that meet the object's requirements, thereby saving time for the object to search for information. Method C provides nearby location information for the object according to the location of the object, thereby enabling the object to understand events around in a timely manner.

The following describes apparatus embodiments of this application, which may be used for performing the method embodiments of this application. For details not disclosed in the apparatus embodiments of this application, refer to the method embodiments of this application.

FIG. 14 shows a block diagram of an information display apparatus according to an embodiment of this application. The apparatus has a function of implementing the foregoing information display method, and the function may be implemented by hardware or may be implemented by hardware executing corresponding software. This apparatus may be terminal device 10 described above or may be disposed in the terminal device 10. The apparatus 1400 may include: an interface display module 1410, a label display module 1420, and an information display module 1430.

The interface display module 1410 is configured to display an interface for displaying information, the interface displaying a map of a target region.

The label display module 1420 is configured to display, in the interface, at least one information label related to the target region, and mark a geographic location associated with the information label on the map, where each information label corresponding to at least one piece of information.

The information display module 1430 is configured to display, in response to an operation on a target information label in at least one information label, information corresponding to the target information label.

In one embodiment, the label display module 1420 is configured to display the at least one information label in the interface, and display a marking point corresponding to each information label on the map. The information label and the marking point corresponding to the information label are associatively displayed, and a display position of the marking point corresponding to the information label on the map corresponds to a geographic location associated with the information label.

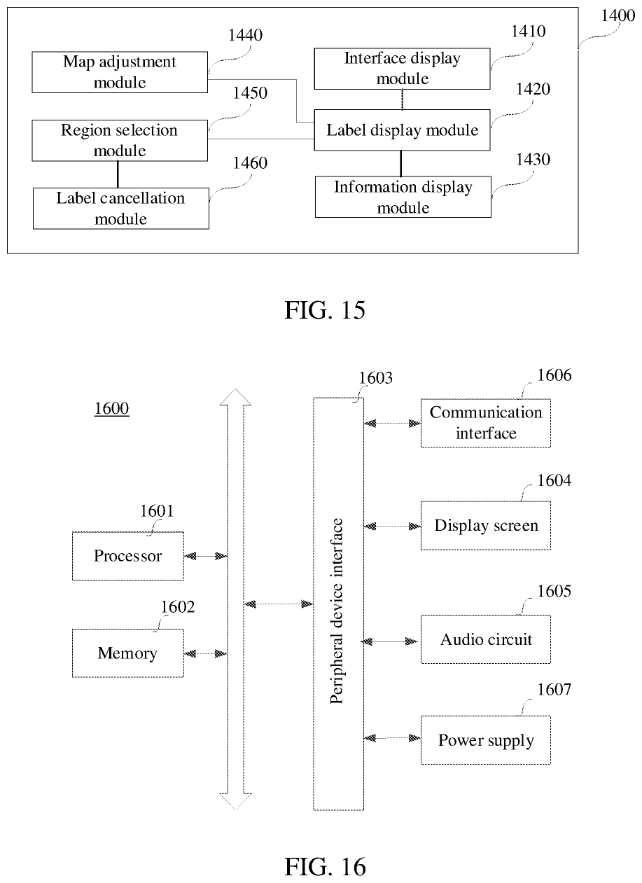

In one embodiment, as shown in FIG. 15, the apparatus 1400 further includes: a map adjustment module 1440.

The map adjustment module 1440 is configured to display a map of the adjusted target region in the interface in response to a zoom operation on the map.

The label display module 1420 is further configured to display, in the interface, at least one information label related to the adjusted target region, and mark a geographic location associated with the information label on the map.

In one embodiment, the map adjustment module 1440 is configured to display, in a two-dimensional plane style, the map of the adjusted target region in the interface in a case that a zoom ratio of the map satisfies a first condition; or display, in a three-dimensional style, the map of the adjusted target region in the interface in a case that a zoom ratio of the map satisfies a second condition.

In one embodiment, as shown in FIG. 15, the apparatus 1400 further includes: a region selection module 1450.

The region selection module 1450 is configured to display, in the interface, a map of a selected region in the target region in response to a region selection operation.

The label display module 1420 is further configured to display, in the interface, at least one information label related to the selected region, and mark a geographic location associated with the information label on the map.

In one embodiment, the region selection module 1420 is configured to obtain an operation trajectory corresponding to the region selection operation in response to the region selection operation; determine the selected region from the target region based on the operation trajectory; and display the map of the selected region in the interface.

In one embodiment, the region selection module 1420 is configured to obtain an operation position and operation duration corresponding to the region selection operation in response to the region selection operation; determine the selected region from the target region based on the operation position and operation duration; and display the map of the selected region in the interface.

In one embodiment, as shown in FIG. 15, the apparatus 1400 further includes: a label cancellation module 1460.

The label cancellation module 1460 is configured to cancel the display of the information labels displayed in the interface in response to an operation on a target control displayed in the interface.

In one embodiment, the interface further displays at least one category label, and different category labels correspond to information labels belonging to different information categories. The label display module 1420 is further configured to display, in response to an operation on a target category label in the at least one category label, at least one information label corresponding to the target category label in the interface, and mark a geographic location associated with the information label on the map.

In one embodiment, the at least one category label includes at least one of the following: a category label selected or set by the target object, a category label determined based on a historical preference of the target object, and a category label determined based on an attribute feature of the target object. In one embodiment, the label display module 1420 is further configured to, for an information label corresponding to specific information, display a video playback window in the information label corresponding to the specific information, and play video content of the specific information in the video playback window.

In one embodiment, the information label corresponding to the specific information further displays at least one of the following information: occurrence time of the specific information, views of the specific information, and alarm prompt for the specific information.

In one embodiment, the label display module 1420 is further configured to send an information obtaining request to a server, the information obtaining request being used for obtaining information content; and receive the information content from the server, the information content including the information and the geographic location associated with the information.

In one embodiment, the label display module 1420 is further configured to display each information label in a different display style based on index information corresponding to each information label, where the index information includes at least one of the following: hot, views, occurrence time, and likes.

In one embodiment, the interface display module 1410 is further configured to display a map of an initial region in the interface in a case of initial display of the interface, where the initial region includes any one of the following: a current region of the target object, a set region of the target object, a historical focus region of the target object, and a preference focus region of the target object.

The label display module 1420 is further configured to display at least one information label related to the initial region in the interface, and mark a geographic location associated with the information label on the map.

In one embodiment, the interface display module 1410 is further configured to obtain a real-time region of the target object at a set time interval; and display a map of the real-time region in the interface.

The label display module 1420 is further configured to display at least one information label related to the real-time region in the interface, and mark a geographic location associated with the information label on the map.

In this embodiment, by combining information and maps, a map of a region and information labels in the region are displayed in the interface, and geographic locations associated with the information labels are marked on the map to achieve associated display of information and geographic locations. This embodiment provides a novel information display method, by which a user can learn a geographic location associated with information more clearly and intuitively, such as learning a location of occurrence of an event contained in the information.

FIG. 16 shows a block diagram of a terminal device 1600 according to an embodiment of this application. The terminal device 1600 may be an electronic device such as a mobile phone, a tablet computer, a PC, a wearable device, a vehicle terminal device, a VR device, or an AR device. The terminal device 1600 may be the terminal device 10 described in the embodiment of FIG. 1.

terminal device 1600 includes: a processor 1601 and a memory 1602.

The processor 1601 may include one or more processing cores, for example, a 4-core processor or an 8-core processor. The processor 1601 may be implemented in at least one hardware form of a digital signal processor (DSP), a field programmable gate array (FPGA), or a programmable logic array (PLA). The processor 1601 may alternatively include a main processor and a coprocessor. The main processor is a processor configured to process data in an awake state, and is also referred to as a central processing unit (CPU). The coprocessor is a low power consumption processor configured to process data in a standby state. In some embodiments, the processor 1601 may be integrated with a graphics processing unit (GPU). The GPU is configured to render and draw content to be displayed on a display screen. In some embodiments, the processor 1601 may further include an artificial intelligence (AI) processor. The AI processor is configured to process computing operations related to machine learning.

Memory 1602 may include one or more computer-readable storage media. The computer-readable storage medium may be non-transient. Memory 1602 may further include a high-speed random access memory and a nonvolatile memory, for example, one or more disk storage devices or flash storage devices. The memory 1602 stores at least one instruction, at least one program, a code set, or an instruction set, and the at least one instruction, the at least one program, the code set, or the instruction set is loaded and executed by the processor 1601 to implement the foregoing information display method.

In some embodiments, the terminal device 1600 may alternatively include: a peripheral device interface 1603 and at least one peripheral device. The processor 1601, the memory 1602, and the peripheral device interface 1603 may be connected through a bus or a signal cable. Each peripheral device may be connected to peripheral device interface 1603 through a bus, a signal cable, or a circuit board. Specifically, the peripheral device may include at least one of a display screen 1604, an audio circuit 1605, a communication interface 1606, and a power supply 1607.

A person skilled in the art may understand that the structure shown in FIG. 16 constitutes no limitation on the terminal device 1600, and the terminal device may include more or fewer components than those shown in the figure, or some components may be combined, or a different component deployment may be used.

In one embodiment, a computer-readable storage medium is further provided, the storage medium storing at least one instruction, at least one program, a code set, or an instruction set, and the at least one instruction, the at least one program, the code set, or the instruction set being loaded and executed by the processor of the terminal device to implement the foregoing information display method.

In some embodiments of this application, the computer-readable storage medium may include: a read-only memory (ROM), a random-access memory (RAM), a solid-state drive (SSD), an optical disc, or the like. The RAM may include a resistance random access memory (ReRAM) and a dynamic random access memory (DRAM).

In one embodiment, a computer program product or computer program is further provided, the computer program product or computer program including computer instructions, and the computer instructions being stored in a computer-readable storage medium. A processor of a computer device reads the computer instructions from the computer-readable storage medium, the processor executes the computer instructions, and the computer device is enabled to perform the foregoing information display method.

It is to be understood that the term “plurality” mentioned in the specification means two or more. The term “and/or” describes an association relationship between associated objects and represents three relationships. For example, A and/or B may represent the following three cases: only A exists, both A and B exist, and only B exists. The character “/” generally indicates an “or” relationship between successive associated objects. In addition, the step numbers described in this specification merely illustrate a possible execution sequence of the steps. In some other embodiments, the steps may not be performed according to the number sequence. For example, two steps with different numbers may be performed simultaneously, or two steps with different numbers may be performed according to a sequence contrary to the sequence shown in the figure. This is not limited to the embodiments of this application.

Technical features of the foregoing embodiments may be randomly combined. To make description concise, not all possible combinations of the technical features in the foregoing embodiments are described. However, the combinations of these technical features shall be considered as falling within the scope recorded by this specification provided that no conflict exists.

The foregoing descriptions are merely exemplary embodiments of this application, but are not intended to limit this application. Any modification, equivalent replacement, or improvement made within the spirit and principle of this application shall fall within the protection scope of this application.

What is claimed is:

1. An information display method, performed by a terminal device, the method comprising:
displaying an interface presenting a map of a geographic region;
at least one information label related to the geographic region in the interface, and marking a geographic location associated with the information label on the map, each information label corresponding to at least one piece of information; and
displaying information corresponding to a target information label in response to an operation on the target information label.

2. The method according to claim 1, wherein the at least one information label related to the geographic region in the interface, and marking a geographic location associated with the information label on the map comprises:
displaying the at least one information label in the interface, and displaying a marking point corresponding to each information label on the map, wherein a display position of the marking point on the map is a geographic location associated with the information label corresponding to the marking point; and
wherein the information label and the marking point corresponding to the information label are associatively displayed, and the display position of the marking point corresponding to the information label on the map corresponds to the geographic location associated with the information label.

3. The method according to claim 1, wherein after the at least one information label related to the geographic region in the interface, and marking a geographic location associated with the information label on the map, the method further comprises:
displaying a map of the adjusted geographic region in the interface in response to a zoom operation on the map; and
displaying at least one information label related to the adjusted geographic region in the interface, and marking a geographic location associated with the information label on the map.

4. The method according to claim 3, wherein a display style of the map comprises: a two-dimensional plane style and a three-dimensional style; and
the displaying a map of the adjusted geographic region in the interface comprises:
displaying, in the two-dimensional plane style, the map of the adjusted geographic region in the interface in a case that a zoom ratio of the map satisfies a first condition;
or
displaying, in the three-dimensional style, the map of the adjusted geographic region in the interface in a case that a zoom ratio of the map satisfies a second condition.

5. The method according to claim 1, wherein after the at least one information label related to the geographic region in the interface, and marking a geographic location associated with the information label on the map, the method further comprises:
displaying a map of a selected region in the geographic region in the interface, in response to a region selection operation; and
displaying at least one information label related to the selected region in the interface, and marking a geographic location associated with the information label on the map.

6. The method according to claim 5, wherein the displaying a map of a selected region in the geographic region in the interface, in response to a region selection operation comprises:
obtaining an operation trajectory corresponding to the region selection operation in response to the region selection operation;
determining the selected region from the geographic region based on the operation trajectory; and
displaying the map of the selected region in the interface.

7. The method according to claim 5, wherein the displaying a map of a selected region in the geographic region in the interface, in response to a region selection operation comprises:
obtaining an operation position and operation duration corresponding to the region selection operation in response to the region selection operation;
determining the selected region from the geographic region based on the operation position and operation duration; and
displaying the map of the selected region in the interface.

8. The method according to claim 5, wherein before the displaying a map of a selected region in the geographic region in the interface, in response to a region selection operation, the method further comprises:
canceling the display of the information labels displayed in the interface in response to an operation on a target control displayed in the interface.

9. The method according to claim 1, wherein the interface further displays at least one category label, and different category labels correspond to information labels belonging to different information categories; and
after the displaying at least one information label related to the geographic region in the interface, and marking a geographic location associated with the information label on the map, the method further comprises:
displaying at least one information label corresponding to the target category label in the interface in response to an operation on a target category label in the at least one category label, and marking a geographic location associated with the information label on the map.

10. The method according to claim 9, wherein the at least one category label comprises at least one of the following: a category label selected or set by the target object, a category label determined based on a historical preference of the target object, and a category label determined based on an attribute feature of the target object.

11. The method according to claim 1, wherein the method further comprises:
for an information label corresponding to specific information, displaying a video playback window in the information label corresponding to the specific information, and playing video content of the specific information in the video playback window.

12. The method according to claim 11, wherein the information label corresponding to the specific information further displays at least one of the following information: occurrence time of the specific information, views of the specific information, and alarm prompt for the specific information.

13. The method according to claim 1, wherein the method further comprises:
transmitting an information obtaining request to a server, the information obtaining request being used for obtaining information in the geographic region; and
receiving label information and a geographic location, transmitted by the server, of the information in the geographic region, wherein the label information is used for displaying an information label corresponding to the information.

14. The method according to claim 1, wherein the method further comprises:
displaying each information label in a different display style based on index information corresponding to each information label, wherein.
the index information comprises at least one of the following: hot, views, occurrence time, and likes.

15. The method according to claim 1, wherein the method further comprises:
displaying a map of an initial region in the interface in a case of initial display of the interface, wherein the initial region comprises any one of the following: a current region of the target object, a set region of the target object, a historical focus region of the target object, and a preference focus region of the target object; and
displaying at least one information label related to the initial region in the interface, and marking a geographic location associated with the information label on the map.

16. The method according to claim 1, wherein the method further comprises:
obtaining a real-time region of the target object at a set time interval;
displaying a map of the real-time region in the interface; and
displaying at least one information label related to the real-time region in the interface, and marking a geographic location associated with the information label on the map.

17. A terminal device, the terminal device comprising a processor and a memory, the memory storing at least one instruction, at least one program, a code set, or an instruction set, and the at least one instruction, the at least one program, the code set, or the instruction set being loaded and executed by the processor to implement an information display method comprising:
displaying an interface presenting a map of a geographic region;
displaying at least one information label related to the geographic region in the interface, and marking a geographic location associated with the information label on the map, each information label corresponding to at least one piece of information; and
displaying information corresponding to a target information label in response to an operation on the target information label.

18. The terminal device according to claim 17, wherein the displaying at least one information label related to the geographic region in the interface, and marking a geographic location associated with the information label on the map comprises:
displaying the at least one information label in the interface, and displaying a marking point corresponding to each information label on the map, wherein a display position of the marking point on the map is a geographic location associated with the information label corresponding to the marking point; and
wherein the information label and the marking point corresponding to the information label are associatively displayed, and the display position of the marking point corresponding to the information label on the map corresponds to the geographic location associated with the information label.

19. The terminal device according to claim 17, wherein after at least one information label related to the geographic region in the interface, and marking a geographic location associated with the information label on the map, the method further comprises:
displaying a map of the adjusted geographic region in the interface in response to a zoom operation on the map; and
displaying at least one information label related to the adjusted geographic region in the interface, and marking a geographic location associated with the information label on the map.

20. A non-transitory computer-readable storage medium, the computer-readable storage medium storing at least one instruction, at least one program, a code set, or an instruction set, and the at least one instruction, the at least one program, the code set, or the instruction set being loaded and executed by a processor to implement an information display method comprising:
displaying an interface presenting a map of a geographic region;
displaying at least one information label related to the geographic region in the interface, and marking a geographic location associated with the information label on the map, each information label corresponding to at least one piece of information; and
displaying information corresponding to a target information label in response to an operation on the target information label.
